(19) United States
(12) Patent Application Publication
(10) Pub. No.: US 2020/0407859 A1
(43) Pub. Date: Dec. 31, 2020

(54) PHOTOCATALYST FOR WATER SPLITTING, ELECTRODE, AND WATER SPLITTING DEVICE

(71) Applicants: FUJIFILM Corporation, Tokyo (JP); Japan Technological Research Association of Artificial Photosynthetic Chemical Process, Tokyo (JP)

(72) Inventors: Hiroyuki KOBAYASHI, Tokyo (JP); Masahiro ORITA, Tokyo (JP)

(73) Assignees: FUJIFILM Corporation, Tokyo (JP); Japan Technological Research Association of Artificial Photosynthetic Chemical Process, Tokyo (JP)

(21) Appl. No.: 17/020,048

(22) Filed: Sep. 14, 2020

Related U.S. Application Data
(63) Continuation of application No. PCT/JP2019/007407, filed on Feb. 27, 2019.

(30) Foreign Application Priority Data
Mar. 19, 2018 (JP) 2018-051225

(51) Int. Cl. C25B 11/04; C25B 1/00; C25B 1/10; C25B 9/08; C01G 3/00

(52) U.S. Cl. CPC C25B 11/0452; C25B 1/003; C25B 1/10; C01P 2002/54; C25B 9/08; C01G 3/006; C25B 11/0478

(57) ABSTRACT

An object of the present invention is to provide a photocatalyst for water splitting, which can form a water splitting device that is excellent in durability and responsiveness to visible light and excellent in the amount of generated gas, and a water splitting device having the photocatalyst for water splitting. A photocatalyst for water splitting according to the embodiment of the present invention is a photocatalyst for water splitting, which is used for an electrode that generates gas by irradiation with light in a state of being immersed in water, and includes a compound represented by a formula, (Ln)₂CuO₄. In the formula, Ln represents a lanthanoid, and a part of Ln's may be substituted with an element of Groups II to IV of the periodic table.

### CROSS-REFERENCE TO RELATED APPLICATIONS

This application is a Continuation of PCT International Application No. PCT/JP2019/007407 filed on Feb. 27, 2019, which claims priority under 35 U.S.C. § 119(a) to Japanese Patent Application No. 2018-051225 filed on Mar. 19, 2018. The above application is hereby expressly incorporated by reference, in its entirety, into the present application.

### BACKGROUND OF THE INVENTION

### 1. Field of the Invention

The present invention relates to a photocatalyst for water splitting, an electrode, and a water splitting device.

### 2. Description of the Related Art

In recent years, attention has been focused on technologies for producing hydrogen and oxygen by splitting water using a photocatalyst using solar energy from the viewpoint of reducing carbon dioxide emission and producing cleaner energy.

As such photocatalysts for water splitting, JP2014-223629A discloses an oxynitride, a nitride, an oxysulfide, a sulfide, and the like (claim 1 and the like).

### SUMMARY OF THE INVENTION

In recent years, there has been a demand for improved durability of a photocatalyst for water splitting. However, in a case where the nitride and the like described in JP2014-223629A are used as a material for a photocatalyst for water splitting, there is a problem in that the amount of generated gas in a case where a photocatalytic electrode for water splitting is applied to an photocatalytic electrode decreases over time (decrease in durability) in comparison with a case where an oxide is used as a material for a photocatalyst for water splitting.

Therefore, it is conceivable to use the oxide as a photocatalyst for water splitting from the viewpoint of the durability of the photocatalyst for water splitting. However, conventional oxides which have been considered for use as a photocatalyst for water splitting has a wide band gap, which results in poor responsiveness to visible light, and thus there may be a problem that the total amount of gas generated by driving the water splitting device obtained using the conventional oxides for a long time is insufficient (reduction of the amount of generated gas).

An object of the present invention is to provide a photocatalyst for water splitting, which can form a water splitting device that is excellent in durability and responsiveness to visible light and excellent in the amount of generated gas, and a water splitting device having the photocatalyst for water splitting.

The present inventors have performed intensive studies on the above problems and, as a result, have found that in a case where an oxide having a specific composition is used as a photocatalyst for water splitting, a water splitting device excellent in durability and responsiveness to visible light and excellent in the amount of generated gas can be formed, which has led to the present invention.

That is, the present inventors have found that the above-described problems can be solved by the following configurations.

[1] A photocatalyst for water splitting, which is used for an electrode that generates gas by irradiation with light in a state of being immersed in water, the photocatalyst comprising a compound represented by Formula (1) described later.

In Formula (1) described later, Ln represents a lanthanoid, and a part of Ln's may be substituted with an element of Groups II to IV of the periodic table.

[2] The photocatalyst for water splitting according to [1], further comprising a co-catalyst.

[3] The photocatalyst for water splitting according to [1] or [2], in which the compound represented by Formula (1) described later is a compound represented by Formula (2) described later.

In Formula (2) described later, Ln represents a lanthanoid, A represents an element of Groups II to IV of the periodic table, and n represents a numerical value of 0 to 1.

[4] The photocatalyst for water splitting according to any one of [1] to [3], in which in Formula (1) described later, Ln is La or Nd.

[5] The photocatalyst for water splitting according to [4], in which in Formula (1) described later, Ln represents La, and a part of La's may be substituted with an element of Group II of the periodic table or an element of Group III of the periodic table except for the lanthanoid.

[6] The photocatalyst for water splitting according to [5], in which a part of La's are substituted with Sr or Y.

[7] The photocatalyst for water splitting according to [4], in which in Formula (1) described later, Ln represents Nd, and a part of Nd's may be substituted with an element of Group II of the periodic table or an element of Group III of the periodic table.

[8] The photocatalyst for water splitting according to [7], in which a part of Nd's are substituted with Ce or Y.

[9] An electrode comprising the photocatalyst for water splitting according to any one of [1] to [8].

[10] A water splitting device for generating gases from a cathode electrode and an anode electrode by irradiating the cathode electrode and the anode electrode each disposed in a bath filled with water with light, wherein at least one of the cathode electrode or the anode electrode includes the photocatalyst for water splitting according to any one of [1] to [8].

[11] The water splitting device according to [10], in which the cathode electrode includes La₂CuO4 in which a part of La's may be substituted with an element of Group II of the periodic table or an element of Group III of the periodic table except for a lanthanoid, as the photocatalyst for water splitting, and a potential at a lower end of a conduction band in the anode electrode is −5.2 eV or more.

[12] The water splitting device according to [10], in which a potential at an upper end of a valence band in the cathode electrode is −4.8 eV or less, and the anode electrode includes Nd₂CuO4 in which a part of Nd's may be substituted with an element of Group II of the periodic table or an element of Group III of the periodic table as the photocatalyst for water splitting.

As described will be later, according to the present invention, a photocatalyst for water splitting, which can form a water splitting device that is excellent in durability and responsiveness to visible light and excellent in the amount of generated gas, and a water splitting device having the photocatalyst for water splitting can be provided.

### BRIEF DESCRIPTION OF THE DRAWINGS

FIG. 1 is a perspective view schematically illustrating one embodiment of a water splitting device of the present invention.

FIG. 2 is a graph for describing an absorption edge wavelength.

FIG. 3 is a perspective view schematically illustrating one embodiment of a water splitting device of the present invention.

### DESCRIPTION OF THE PREFERRED EMBODIMENTS

Hereinafter, a photocatalyst for water splitting of the embodiment of the present invention and a water splitting device formed using the photocatalyst for water splitting will be described.

A numerical value range represented using “to” in the present invention means a range including the numerical values described before and after “to” as the lower limit and the upper limit respectively.

In the present invention, visible light is light having a wavelength visible to the human eye among electromagnetic waves, and specifically, light in a wavelength range of 380 to 780 nm.

In a case of a photocatalyst that generates gas by splitting water, the amount of generated gas and the photocurrent density have a correlation therebetween, and it can be said that the higher the photocurrent density is, the more the amount of generated gas is. Therefore, in the section of “Examples” described later, the change of the photocurrent density over time was measured using a photocatalytic electrode having a photocatalyst for water splitting. That is, in a case where the change in photocurrent density over time is small, it can be determined that the change in the amount of generated gas over time is small (excellent in durability).

Hereinafter, the reason why the photocurrent density and the amount of generated gas are correlated will be described.

In a case of using a photocatalytic electrode in which a photocatalyst is formed on an electron collecting layer (conductive layer), the total amount of electrons transferred between water and the photocatalytic electrode can be measured by a photoelectrochemical measurement of a three-electrode system. The relationship between the quantity of transferred electrons (quantity of electricity) on the electrode surface and the amount of generated gas is proportional according to Faraday's law, and thus in a case where photocurrent density is measured, the amount of generated gas can be derived based on the photocurrent density value.

[Photocatalyst for Water Splitting]

A photocatalyst for water splitting of the embodiment of the present invention contains a compound represented by Formula (1) (hereinafter, also referred to as “specific oxide”) described later.

The photocatalyst for water splitting according to the embodiment of the present invention can form a water splitting device that is excellent in durability and responsiveness to visible light and excellent in the amount of generated gas. This is presumed to be due to the following reasons.

In a photocatalyst for water splitting, electrons need to be excited from the valence band to the conduction band by sunlight, and the excited electrons need to have energy to split water. The wavelength of the sunlight that can be used by the photocatalyst for water splitting is determined by the band gap of the material constituting the photocatalyst for water splitting. The band gap corresponds to the energy gap between the valence band and the conduction band. The narrower the band gap is, the wider the absorption wavelength range is.

The present inventors have found that in a case where a specific oxide is used, the d orbital of Cu constituting the specific oxide is split by the crystal field.

The lower band in the split d orbital of Cu is occupied by electrons, and the upper band is empty. Therefore, Cu becomes an insulator although a divalent oxide generally has conductivity. In addition, in the case of Cu, the band gap created after the splitting is a gap suitable for absorbing visible light. This is considered to be the reason why the above photocatalyst is excellent in responsiveness to visible light, and the water splitting device obtained by using the above photocatalyst is excellent in the amount of generated gas.

Further, the lower band of the split Cu becomes deeper than 2p of oxygen or is hybridized. Therefore, electrons excited by light absorption includes the 2p orbital of oxygen and have high resistance to oxidation reaction, and thus have high durability as a photocatalyst.

On the other hand, in the conventional photocatalyst, a nitride or an oxynitride has been used in order to obtain a band gap suitable for absorbing visible light. This is because the 2p orbital of nitrogen forms a level shallower than the 2p orbital of oxygen, and in this case, electrons photoexcited includes the 2p orbital of nitrogen, and the oxidation resistance is not high. That is, the durability is low even as a photocatalyst.

<Specific Oxide>

A specific oxide is a compound represented by Formula (1).

(Ln)₂CuO₄ Formula (1)

In Formula (1), Ln represents a lanthanoid. Lanthanoids include La, Ce, Pr, Nd, Pm, Sm, Eu, Gd, Tb, Dy, Ho, Er, Tm, Yb, and Lu. Among these, Ln is preferably La, Nd, Sm, or Pr and more preferably La or Nd, from the viewpoint that the responsiveness to visible light and the amount of generated gas in a case of being applied to a water splitting device are more excellent.

Here, a part of Ln's may be substituted with an element of Groups II to IV of the periodic table. In present specification, an element that partially substitutes Ln's is also referred to as a “substitution element”.

In a case where the substitution element is a lanthanoid of Group III of the periodic table, Ln in Formula (1) and the substitution element are elements different from each other. For example, in a case where Ln in Formula (1) is Nd, the substitution element is a lanthanoid other than Nd (for example, Ce).

Among these, the substitution element is preferably an element of Group II or Group III of the periodic table from the viewpoint that the responsiveness to visible light and the amount of generated gas in a case of being applied to a water splitting device are more excellent, more preferably an alkaline earth metal element (Ca, Sr, Ba, and Ra) of Group II of the periodic table or Ce, Pr, Sm, Sc, or Y of Group III of the periodic table, still more preferably Sr, Ce, or Y and, particularly preferably Sr or Ce.

Ln may be substituted with one kind of the substitution element or with two or more kinds of the substitution elements.

In a case where Ln is La, the substitution element is preferably an element of Group II of the periodic table or an element of Group III of the periodic table except for a lanthanoid from the viewpoint that the responsiveness to visible light and the amount of generated gas in a case of being applied to a water splitting device are more excellent, more preferably an alkaline earth metal element of Group II of the periodic table or Sc or Y of Group III of the periodic table, and particularly preferably Sr or Y.

In a case where Ln is Nd, the substitution element is preferably an element of Group II of the periodic table or an element of Group III of the periodic table from the viewpoint that the responsiveness to visible light and the amount of generated gas in a case of being applied to a water splitting device are more excellent, more preferably an alkaline earth metal element of Group II of the periodic table or Ce, Sm, or Y of Group III of the periodic table, and particularly preferably Ce or Y.

In Formula (1), it is standard that the compositional ratio of Ln, Cu, and oxygen atoms is 2:1:4 in the mentioned order, but the compositional ratio may deviate from 2:1:4 as long as a crystal structure which is the same as the crystal structure in a case where the compositional ratio is 2:1:4 is represented.

The compound represented by Formula (1) is preferably a compound represented by Formula (2), from the viewpoint that the responsiveness to visible light and the amount of generated gas in a case of being applied to a water splitting device are more excellent.

(Ln)₂₋ₙAₙCuO₄ Formula (2)

In Formula (2), Ln has the same meaning as Ln in Formula (1), the preferred aspect is also the same, and thus the description is omitted.

A represents an element that is substituted for a part of Ln's (the above-mentioned substitution element) and has the same meaning as the substitution element described in Formula (1). Since the preferred aspect is also the same, the description thereof is omitted.

n represents a numerical value of 0 to 1, preferably 0 to 0.5, more preferably 0 to 0.2, still more preferably 0.01 to 0.2, and particularly preferably 0.01 to 0.15. In a case where n is 0.01 or more, an effect of doping a carrier (electron or hole) or introducing a strain into a crystal lattice is exhibited. In a case where n is 0.2 or less, high mobility due to high crystallinity can be obtained.

The compound represented by Formula (2) is preferably a compound represented by Formula (3) or a compound represented by Formula (4), from the viewpoint that the responsiveness to visible light and the amount of generated gas in a case of being applied to a water splitting device are more excellent.

(La)₂₋ₙ₁A¹ₙ₁CuO₄ Formula (3)

(Nd)₂₋ₙ₂A²ₙ₂CuO₄ Formula (4)

In Formula (3), A¹ is an element of Group II of the periodic table or an element of Group III of the periodic table except for a lanthanoid, from the viewpoint that the responsiveness to visible light and the amount of generated gas in a case of being applied to a water splitting device are more excellent, preferably an alkaline earth metal element of Group II of the periodic table or Sc or Y of Group III of the periodic table, and more preferably Sr or Y.

n1 represents a numerical value of 0 to 1, preferably 0 to 0.5, more preferably 0 to 0.2, still more preferably 0.01 to 0.2, and particularly preferably 0.01 to 0.15. In a case where n1 is 0.01 or more, an effect of doping a carrier (electron or hole) or introducing a strain into a crystal lattice is exhibited. In a case where n1 is 0.2 or less, high mobility due to high crystallinity can be obtained.

In Formula (4), A² is an element of Group II of the periodic table or an element of Group III, from the viewpoint that the responsiveness to visible light and the amount of generated gas in a case of being applied to a water splitting device are more excellent, preferably an alkaline earth metal element of Group II of the periodic table or Ce, Y, Sm of Group III of the periodic table, and more preferably Ce or Y.

n2 represents a numerical value of 0 to 1, preferably 0 to 0.5, more preferably 0 to 0.2, still more preferably 0.01 to 0.2, and particularly preferably 0.01 to 0.15. In a case where n2 is 0.01 or more, an effect of doping a carrier (electron or hole) or introducing a strain into a crystal lattice is exhibited. In a case where n2 is 0.2 or less, high mobility due to high crystallinity can be obtained.

The content of the specific oxide is preferably 70% to 100% by mass, more preferably 80% to 100% by mass, and particularly preferably 90% to 100% by mass with respect to the total mass of the photocatalyst, due to that fact that the durability and the responsiveness to visible light of the photocatalyst for water splitting are more excellent, and the amount of generated gas is more excellent in a case of being applied to the water splitting device.

The specific oxide may be used singly or in combination of two or more thereof. In a case where the photocatalyst for water splitting contains two or more specific oxides, the total amount of the two or more specific oxides is preferably within the above range.

<Co-Catalyst>

The photocatalyst for water splitting of the embodiment of the present invention may contain a co-catalyst. By supporting the co-catalyst on the photocatalyst, an overvoltage required for water splitting can be suppressed, and the onset potential can be improved.

The co-catalyst is preferably supported on the specific oxide.

Examples of the co-catalyst include metals such as Ti, Mn, Fe, Co, Ni, Cu, Ru, Rh, Pd, Ag, In, W, Ir, Mg, Ga, Ce, Cr, Pb, Pt, and Co, metal compounds (including complex compounds), intermetallic compounds, alloys, oxides, hydroxides, composite oxides, nitrides, oxynitrides, sulfides, and oxysulfides of these metals.

In a case where the photocatalyst for water splitting of the embodiment of the present invention contains the co-catalyst, the content of the co-catalyst is preferably 0.05% to 30% by mass, more preferably 0.1% to 10% by mass, and particularly preferably 0.5% to 5% by mass with respect to the total mass of the photocatalyst for water splitting.

In a case where the photocatalyst for water splitting of the embodiment of the present invention is in the form of a film (electrode type), the co-catalyst is preferably supported on the surface of the specific oxide so that the co-catalyst has a thickness of about 0.1 to 10 nm (more preferably 0.5 to 2 nm). In this case, the thickness of the co-catalyst is a value predicted from a rate obtained by forming a co-catalyst into a film having a sufficient thickness, and a uniform film within the above-described thickness may be formed or a film may be formed in an island shape due to thinness of the film.

<Other Components>

The photocatalyst for water splitting of the embodiment of the present invention may contain a compound other than the above compounds as long as the effects of the present invention can be exhibited.

Specific examples of such compounds include a surface modifier for modifying the surface of the specific oxide and a mixing catalyst used by mixing with the specific oxide.

Examples of the materials constituting the surface modifier include: oxides such as SrTiO₃ doped with at least one element selected from the group consisting of SrTiO₃, TiO₂, Cr, Sb, Ta, Rh, Na, Ga, K, and La, and TiO₂ doped with at least one element selected from the group consisting of Cr, Ni, Nb, Th, Rh, and Sb; sulfide compounds such as ZnS doped with at least one element selected from the group consisting of ZnS, CdS, Cu, Ni, and Pb, CdS doped with Ag, CdₓZn₁₋ₓS (X represents a value greater than 0 and less than 1), CuInS₂, CuIn₅S₈, CuGaS₂, CuGa₃S₅, and CuGa₅S₈; a selenide compound such as CuGaSe₂, CuGa₃Se₅, CuGa₅Se₈, AgₓCu₁₋ₓGaSe₂ (X represents a value greater than 0 and less than 1), AgₓCu₁₋ₓGa₃Se₅ (X represents a value greater than 0 and less than 1), and AgₓCu₁₋ₓGa₅Se₈ (X represents a value greater than 0 and less than 1), AgGaSe₂, AgGa₃Se₅, AgGa₅Se₈, and CuInGaSe₂; and metals such as Mo and Ti.

Examples of the materials constituting the mixing catalyst include a photocatalyst having a photocatalytic function other than the above-described specific oxide and an oxide having no photocatalytic function other than the above-described specific oxide.

Examples of the materials having a photocatalytic function in the mixing catalyst include oxides such as SrTiO₃, TiO₂, SrTiO₃ doped with at least one element selected from the group consisting of Cr, Sb, Ta, Rh, Na, Ga, K, La, TiO₂ doped with at least one element selected from the group consisting of Cr, Ni, Nb, Th, Rh, and Sb, Bi₂WO₆, BiVO₄, BiYWO₆, In₂O₃(ZnO)₃, InTaO₄, InTaO₄:Ni (“Compound:M” indicates that M is doped in an optical semiconductor. The same applies hereinafter), CaTiO₃:Rh, La₂Ti₂O₇:Cr, La₂Ti₂O₇:Cr/Sb, La₂Ti₂O₇:Fe, PbMoO₄:Cr, RbPb₂Nb₃O₁₀, HPb₂Nb₃O₁₀, PbBi₂Nb₂O₉, BiVO₄, BiCu₂VO₆, BiSn₂VO₆, SnNb₂O₆, AgNbO₃, AgVO₃, AgLi_{1/3}Ti_{2/3}O₂, AgLi_{1/3}Sn_{2/3}O₂, WO₃, BaBi₁₋ₓInₓO₃ (X represents a value greater than 0 and less than 1), BaZr₁₋ₓSnₓO₃ (X represents a value greater than 0 and less than 1), BaZr₁₋ₓGeₓO₃ (X represents a value greater than 0 and less than 1), and BaZr₁₋ₓSiₓO₃ (X represents a value greater than 0 and less than 1).

The materials having no photocatalytic function among the mixing catalysts include SiO₂, ZrO₂, and CeO₂.

<Use>

As a specific example of the water splitting method using a photocatalyst, a method for performing a water splitting reaction by irradiating a cell in which a suspension containing a powdery photocatalyst is stored with light, and a method for performing water splitting by irradiating an electrode of a device in which an electrode having a photocatalyst deposited on a conductive substrate and a counter electrode are disposed in a cell in which water is stored with light.

The photocatalyst for water splitting of the embodiment of the present invention can be applied to any of the above-described methods for performing a water splitting reaction.

The photocatalyst for water splitting of the embodiment of the present invention can be used for oxygen generation in water splitting.

In a case where the photocatalyst for water splitting of the embodiment of the present invention is used for oxygen generation, a compound represented by Formula (4) ((Nd)₂₋ₙ₂A²ₙ₂CuO₄) is preferable among the above-mentioned specific oxides. However, in a case where A² is Ce among the compounds represented by Formula (4), n2 is less than 0.08.

In a case where the photocatalyst for water splitting of the embodiment of the present invention is used for oxygen generation, among the co-catalysts described above, metals such as Ir, Co, Fe, Ni, and Cu (among these, Ir, Co, or Ni is preferable), and oxides of these metals or hydroxides of these metals are preferable.

The photocatalyst for water splitting of the embodiment of the present invention can be used for hydrogen generation in water splitting.

In a case where the photocatalyst for water splitting of the embodiment of the present invention is used for hydrogen generation, a compound represented by Formula (3) ((La)₂₋ₙ₁A¹ₙ₁CuO₄) and a compound represented by Formula (4) ((Nd)₂₋ₙ₂A²ₙ₂CuO₄) are preferable among the above-mentioned specific oxides. However, in Formula (4), A² is Ce, and n2 is 0.08 or more.

In a case where the photocatalyst for water splitting of the embodiment of the present invention is used for hydrogen generation, among the above-mentioned co-catalysts, metals such as Pt, Ir, Ru, and Pd (among these, Pt or Ru is preferable), oxides of these metals, or hydroxides of these metals are preferable.

<Production Method of Photocatalyst for Water Splitting>

The photocatalyst for water splitting of the embodiment of the present invention can be produced by a known method. For example, it can be produced by mixing oxides of elements constituting the specific oxides at the desired ratio and then calcinating the resultant mixture.

[Electrode]

The electrode of the embodiment of the present invention is an electrode containing a photocatalyst for water splitting, which contains a specific oxide. The electrode of the embodiment of the present invention may be an anode electrode used for oxygen generation or a cathode electrode used for hydrogen generation.

The configuration of the electrode of the embodiment of the present invention can be, for example, the same as the configuration of a cathode electrode or an anode electrode in a water splitting device described later, and thus the description thereof is omitted.

[Water Splitting Device]

The water splitting device of the embodiment of the present invention is a water splitting device that generates gases from a cathode electrode and an anode electrode by irradiating the cathode electrode and the anode electrode each disposed in a bath filled with water with light, in which at least one of the cathode electrode or the anode electrode includes a photocatalyst for water splitting containing a specific oxide.

One aspect of the water splitting device of the embodiment of the present invention will be described in detail with reference to the drawings.

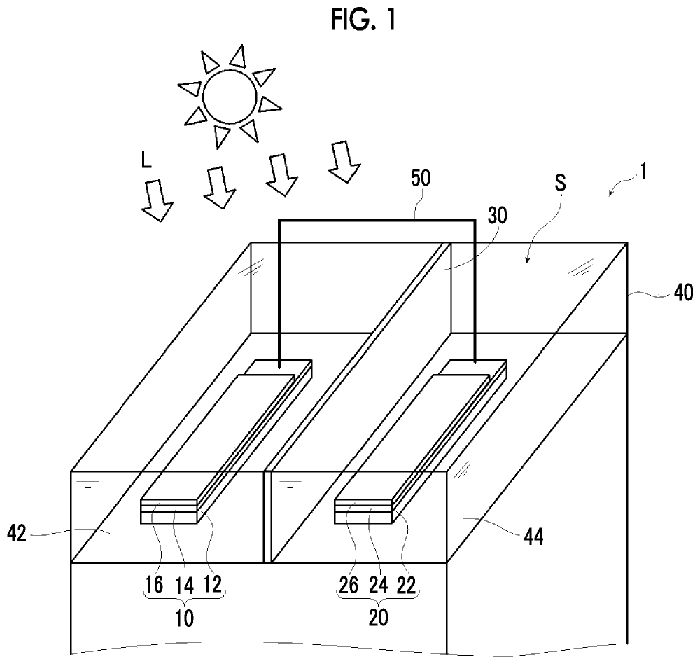

FIG. 1 is a perspective view schematically illustrating a device 1 that is one embodiment of the water splitting device of the embodiment of the present invention. The device 1 is a device that generates gases from an anode electrode 10 and a cathode electrode 20 by irradiation with light L. Specifically, in a case in which an electrolytic solution S that will be described later contains water as the main component, water is split by the light L, oxygen is generated from the anode electrode 10, and hydrogen is generated from the cathode electrode 20.

As shown in FIG. 1, the device 1 includes: a bath 40 filled with an electrolytic solution S; the anode electrode 10 and the cathode electrode 20 each disposed inside the bath 40; and a diaphragm 30 disposed between the anode electrode 10 and the cathode electrode 20 and inside the bath 40. The anode electrode 10, the diaphragm 30, and the cathode electrode 20 are arranged in this order along the direction intersecting the traveling direction of the light L.

As the light L to be irradiated, visible light such as sunlight, ultraviolet light, infrared light, or the like can be used, and among these, sunlight whose amount is infinite is preferable.

<Bath>

The inside of the bath 40 is divided by the diaphragm 30 into an anode electrode chamber 42 in which the anode electrode 10 is disposed and a cathode electrode chamber 44 in which the cathode electrode 20 is disposed.

Although not limited thereto, the bath 40 is disposed to be inclined so that the amount of incident light per unit area with respect to the anode electrode 10 and the cathode electrode 20 increases. The bath 40 is sealed so that the electrolytic solution S does not flow out in a state where the bath 40 is inclined.

Regarding a specific example of the material that constitutes the bath 40, a material having excellent corrosion resistance (particularly, alkali resistance) is preferable, and examples thereof include polyacrylate, polymethacrylate, polycarbonate, polypropylene, polyethylene, polystyrene, and glass.

(Electrolytic Solution)

As shown in FIG. 1, the inside of the bath 40 is filled with the electrolytic solution S, and at least a portion of each of the anode electrode 10, the cathode electrode 20, and the diaphragm 30 is immersed in the electrolytic solution S.

The electrolytic solution S is a solution in which an electrolyte is dissolved in water. Specific examples of the electrolytes include sulfuric acid, sodium sulfate, potassium hydroxide, potassium phosphate, and boric acid.

The pH of the electrolytic solution S is preferably 6 to 11. In a case where the pH of the electrolytic solution S is within the above range, there is an advantage that the solution can be handled safely. The pH of the electrolytic solution S can be measured using a known pH meter.

The concentration of the electrolyte in the electrolytic solution S is not particularly limited; however, it is preferable that the pH of the electrolytic solution S is adjusted to be in the above-described range.

<Anode Electrode>

The anode electrode 10 is disposed in the anode electrode chamber 42.

The anode electrode 10 has: a first substrate 12; a first conductive layer 14 disposed on the first substrate 12; and a first photocatalyst layer 16 disposed on the first conductive layer 14. The anode electrode 10 is disposed in the bath 40 so that the first photocatalyst layer 16, the first conductive layer 14, and the first substrate 12 are arranged in this order from the side irradiated with the light L.

In the example of FIG. 1, the anode electrode 10 has a flat plate shape; however, the shape is not limited to this. The anode electrode 10 may be in a punched metal form, a mesh form, or a lattice form, or the anode electrode 10 may be a porous body having penetrating pores.

The anode electrode 10 is electrically connected to the cathode electrode 20 by a conducting wire 50. FIG. 1 shows an example in which the anode electrode 10 and the cathode electrode 20 are connected by the conducting wire 50; however, the mode of connection is not particularly limited as long as the electrodes are electrically connected.

The thickness of the anode electrode 10 is preferably 0.1 to 5 mm, and more preferably 0.5 to 2 mm.

(First Substrate)

A first substrate 12 is a layer that supports the first conductive layer 14 and the first photocatalyst layer 16.

Specific examples of the material constituting the first substrate 12 include metals, organic compounds (for example, polyacrylate and polymethacrylate), and inorganic compounds (for example, metal oxides such as SrTiO₃, glass, and ceramics).

The thickness of the first substrate 12 is preferably 0.1 to 5 mm, and more preferably 0.5 to 2 mm.

(First Conductive Layer)

Since the anode electrode 10 has the first conductive layer 14, electrons generated by the incidence of the light L on the anode electrode 10 move to the second conductive layer 24 (will be described later) of the cathode electrode 20 via the conducting wire 50.

Specific examples of the material forming the first conductive layer 14 include Sn, Ti, Ta, Au, SrRuO₃, ITO (indium tin oxide), and zinc oxide-based transparent conductive materials (such as Al:ZnO, In:ZnO, and Ga:ZnO). The notation of “metal atom:metal oxide” such as Al:ZnO means that a part of the metal (Zn in the case of Al:ZnO) constituting the metal oxide has been substituted with metal atom (Al in the case of Al:ZnO).

The thickness of the first conductive layer 14 is preferably 50 nm to 1 μm, and more preferably 100 to 500 nm.

A method for forming the first conductive layer 14 is not particularly limited, and includes, for example, a vapor phase growth method (for example, a chemical vapor phase growth method and a sputtering method).

(First Photocatalyst Layer)

In a case where the anode electrode 10 is irradiated with the light L, electrons generated in the first photocatalyst layer 16 move to the first conductive layer 14. On the other hand, as the holes (positive holes) generated in the first photocatalyst layer 16 react with water, oxygen is generated from the anode electrode 10.

The thickness of the first photocatalyst layer 16 is preferably from 100 nm to 10 μm, and more preferably from 300 nm to 2 μm.

Examples of the material constituting the first photocatalyst layer 16 include a photocatalyst for water splitting containing a specific oxide or a photocatalyst for water splitting containing a material other than the specific oxide. However, in a case where a material forming a second photocatalyst layer 26 described later is a photocatalyst for water splitting containing a material other than the specific oxide, the material forming the first photocatalyst layer 16 is a photocatalyst for water splitting containing the specific oxide.

Examples of the materials other than the specific oxides, among the materials capable of constituting the first photocatalyst layer 16, can include oxides such as Bi₂WO₆, BiVO₄, BiYWO₆, In₂O₃ (ZnO)₃, InTaO₄, and InTaO₄:Ni (where the expression “compound:M” indicates that an optical semiconductor is doped with M. The same applies hereinafter), TiO₂:Ni, TiO₂:Ru, TiO₂Rh, TiO₂:Ni/Ta (the expression “compound:M1/M2” indicates that an optical semiconductor is co-doped with M1 and M2. The same applies hereinafter), TiO₂:Ni/Nb, TiO₂:Cr/Sb, TiO₂:Ni/Sb, TiO₂:Sb/Cu, TiO₂:Rh/Sb, TiO₂:Rh/Ta, TiO₂:Rh/Nb, SrTiO₃:Ni/Ta, SrTiO₃:Ni/Nb, SrTiO₃:Cr, SrTiO₃:Cr/Sb, SrTiO₃:Cr/Ta, SrTiO₃:Cr/Nb, SrTiO₃:Cr/W, SrTiO₃:Mn, SrTiO₃:Ru, SrTiO₃:Rh, SrTiO₃:Rh/Sb, SrTiO₃:Ir, CaTiO₃:Rh, La₂Ti₂O₇:Cr, La₂Ti₂O₇:Cr/Sb, La₂Ti₂O₇:Fe, PbMoO₄:Cr, RbPb₂Nb₃O₁₀, HPb₂Nb₃O₁₀, PbBi₂Nb₂O₉, BiVO₄, BiCu₂VO₆, BiSn₂VO₆, SnNb₂O₆, AgNbO₃, AgVO₃, AgLi_{1/3}Ti_{2/3}O₂, AgL_{1/3}Sn_{2/3}O₂, WO₃, BaBi₁₋ₓInₓO₃, BaZr₁₋ₓSnₓO₃, BaZr₁₋ₓGeₓO₃, and BaZr₁₋ₓSiₓO₃; oxynitrides such as LaTiO₂N, Ca_{0.25}La_{0.75}TiO_{2.25}N_{0.75}, TaON, CaNbO₂N, BaNbO₂N, CaTaO₂N, SrTaO₂N, BaTaO₂N, LaTaO₂N, Y₂Ta₂O₅N₂, (Ga₁₋ₓZnₓ)(N₁₋ₓOₓ), (Zn₁₊ₓGe)(N₂Oₓ) (where x represents a numerical value of 0 to 1), and TiNₓO_{y}F_{z}; nitrides such as NbN and Ta₃N₅; sulfides such as CdS; selenides such as CdSe; L^{x}₂Ti₂S₂O₅ (Lx: Pr, Nd, Sm, Gd, Tb, Dy, Ho, or Er); and oxysulfide compounds including La and In (Chemistry Letters, 2007, 36, 854-855); however, the material is not limited to the materials listed here as examples.

In a case where the first photocatalyst layer 16 is constituted of a photocatalyst for water splitting containing a specific oxide, the absorption edge wavelength of the first photocatalyst layer 16 (photocatalyst for water splitting) is preferably 700 nm or more, more preferably 800 nm or more, and particularly preferably 900 nm or more from the point that the amount of generated gas of the device 1 is more excellent. The upper limit value of the absorption edge wavelength of the first photocatalyst layer 16 (photocatalyst for water splitting) is preferably 1,300 nm or less and more preferably 1,200 nm or less.

Here, in a case where the photocatalyst layer is formed by the vapor phase growth method, the absorption edge wavelength is determined based on the transmission spectrum measured using the photocatalyst layer obtained by the vapor phase growth method. In a case where the photocatalyst layer is formed by a solid phase method (for example, a particle transfer method), a pellet is prepared by molding a powder of a specific oxide used for forming the photocatalyst layer, and the absorption edge wavelength is determined based on the diffuse reflection spectrum measured using the pellet.

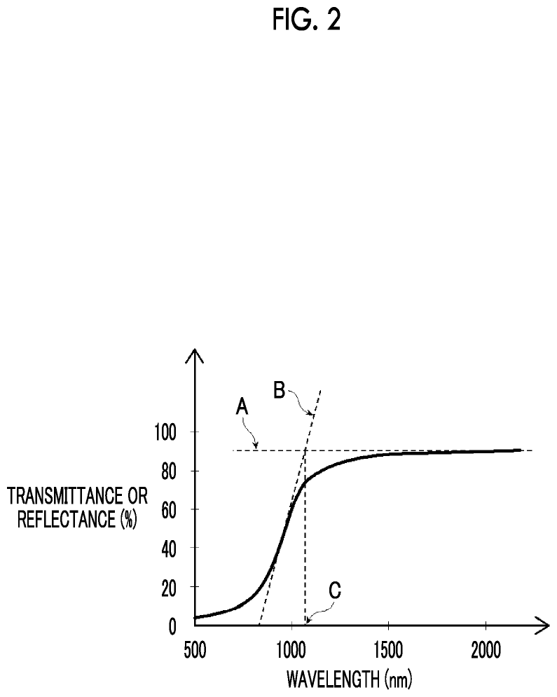

A method for determining an absorption edge wavelength based on the transmission spectrum and the diffuse reflection spectrum will be described with reference to FIG. 2. FIG. 2 is an example of a spectrography (transmission spectrum diagram or diffuse reflection spectrum diagram) of a photocatalyst layer or pellet, where a horizontal axis indicates wavelength (range 300 to 2,000 nm) and a vertical axis indicates transmittance or reflectance. As shown in FIG. 2, a wavelength value C at an intersection of a line A parallel to the horizontal axis indicating the maximum transmittance or the maximum reflectance and a tangent line B at a point at 50% of the maximum transmittance or the maximum reflectance is the absorption edge wavelength (nm).

The method for measuring the absorption edge wavelength according to the embodiment of the in the present invention is as shown in the section of “Examples” described later.

In a case where the first photocatalyst layer 16 is constituted of a photocatalyst for water splitting containing a specific oxide, the carrier density of the first photocatalyst layer 16 (photocatalyst for water splitting) is preferably 1×10¹⁶ cm⁻³ or more and more preferably 1×10¹⁸ cm⁻³ or more from the viewpoint of carrier transport. The upper limit value of the carrier density of the first photocatalyst layer 16 (photocatalyst for water splitting) is preferably 1×10²⁰ cm⁻³ or less and more preferably 1×10¹⁹ cm⁻³ or less from the viewpoint of mobility.

The measurement of the carrier density in the present invention is performed by using a Hall effect measuring device (for example, a system manufactured by Toyo Corporation can be used) by the Van der pauw method. As an electrode for measurement, Al may be used in a case where the carrier conduction type is n-type, and Pt may be used in a case where the carrier conduction type is p-type.

The method for forming the first photocatalyst layer 16 is not particularly limited, and examples thereof include a vapor phase growth method (for example, a chemical vapor phase growth method, a sputtering method, a pulse laser deposition method) and a solid phase method (for example, a particle transfer method).

The first photocatalyst layer 16 may have a co-catalyst supported on its surface. In a case where the co-catalyst is supported, the onset potential and the amount of generated gas become satisfactory. Specific examples of the co-catalyst are as described above.

A method for supporting the co-catalyst is not particularly limited, and examples thereof include an immersion method (for example, a method of immersing the photocatalyst layer in a suspension containing the co-catalyst) and a vapor phase growth method (for example, a sputtering method).

<Cathode Electrode>

The cathode electrode 20 is disposed in the cathode electrode chamber 44.

The cathode electrode 20 has: a second substrate 22; a second conductive layer 24 disposed on the second substrate 22; and a second photocatalyst layer 26 disposed on the second conductive layer 24. The cathode electrode 20 is disposed in the bath 40 so that the second photocatalyst layer 26, the second conductive layer 24, and the second substrate 22 are arranged in this order from the side irradiated with the light L.

In the example of FIG. 1, the cathode electrode 20 has a flat plate shape; however, the shape is not limited to this. The cathode electrode 20 may be in a punched metal form, a mesh form, or a lattice form, or the cathode electrode 20 may be a porous body having penetrating pores.

The thickness of the cathode electrode 20 is preferably 0.1 to 5 mm, and more preferably 0.5 to 2 mm.

(Second Substrate)

A second substrate 22 is a layer that supports a second conductive layer 24 and a second photocatalyst layer 26.

The second substrate 22 may or may not be transparent. Specific examples of the material constituting the second substrate 22 include metals, organic compounds (for example, polyacrylate and polymethacrylate), and inorganic compounds (for example, metal oxides such as SrTiO₃, glass, and ceramics).

The thickness of the second substrate 22 is preferably 0.1 to 5 mm, and more preferably 0.5 to 2 mm.

(Second Conductive Layer)

The holes generated by the incidence of the light L on the cathode electrode 20 (second photocatalyst layer 26) are gathered in the second conductive layer 24. As a result, the holes gathered in the second conductive layer 24 are recombined with the electrons transported from the first conductive layer 14 of the anode electrode 10, and thereby the retention of holes and electrons can be suppressed.

The material constituting the second conductive layer 24 is not particularly limited as long as the material has electrical conductivity, and examples thereof include metals such as Sn, Ti, Ta, Au, Mo, Cr, and W; and alloys thereof.

The thickness of the second conductive layer 24 is preferably 100 nm to 2 μm, and more preferably 200 nm to 1 μm.

Since a method of forming the second conductive layer 24 can be the same as that of the first conductive layer 14, the description thereof is omitted.

(Second Photocatalyst Layer)

In a case where the cathode electrode 20 is irradiated with the light L, holes generated in the second photocatalyst layer 26 move to the second conductive layer 24. On the other hand, as the electrons generated in the second photocatalyst layer 26 react with water, hydrogen is generated from the cathode electrode 20.

The thickness of the second photocatalyst layer 26 is preferably 100 nm to 10 μm, and more preferably 500 nm to 5 μm.

Examples of the material constituting the second photocatalyst layer 26 include a photocatalyst for water splitting containing a specific oxide or a photocatalyst for water splitting containing a material other than the specific oxide. However, in a case where the material forming the first photocatalyst layer 16 described above is a photocatalyst for water splitting containing a material other than the specific oxide, the material forming the second photocatalyst layer 26 is a photocatalyst for water splitting containing the specific oxide.

Specific oxide examples of the material other than the specific oxide, among the materials capable of constituting the second photocatalyst layer 26, include oxides, nitrides, oxynitrides, and (oxy)chalcogenides, each containing at least one kind of metal atoms selected from the group consisting of Ti, V, Nb, Ta, W, Mo, Zr, Ga, In, Zn, Cu, Ag, Cd, Cr and Sn, and GaAs, GaInP, AlGaInP, CdTe, a CIGS compound semiconductor (compound semiconductor containing Cu, In, Ga, and Se as main raw materials), or a CZTS compound semiconductor (for example, Cu₂ZnSnS₄) is preferred; a CIGS compound semiconductor having a chalcopyrite crystal structure or a CZTS compound semiconductor such as Cu₂ZnSnS₄ is more preferred; while a CIGS compound semiconductor having a chalcopyrite crystal structure is particularly preferred.

In a case where the second photocatalyst layer 26 is constituted of a photocatalyst for water splitting containing a specific oxide, the absorption edge wavelength of the second photocatalyst layer 26 (photocatalyst for water splitting) is preferably 700 nm or more, more preferably 800 nm or more, and particularly preferably 900 nm or more from the point that the amount of generated gas of the device 1 is more excellent. The upper limit value of the absorption edge wavelength of the second photocatalyst layer 26 (photocatalyst for water splitting) is preferably 1,300 nm or less and more preferably 1,200 nm or less.

In a case where the second photocatalyst layer 26 is constituted of a photocatalyst for water splitting containing a specific oxide, the carrier density of the second photocatalyst layer 26 (photocatalyst for water splitting) is preferably 1×10¹⁶ cm⁻³ or more and more preferably 1×10¹⁸ cm⁻³ or more from the viewpoint of carrier transport. The upper limit value of the carrier density of the second photocatalyst layer 26 (photocatalyst for water splitting) is preferably 1×10²⁰ cm⁻³ or less and more preferably 1×10¹⁹ cm⁻³ or less from the viewpoint of mobility.

A method for forming the second photocatalyst layer 26 can be the same as the method for forming the first photocatalyst layer 16, and thus the description thereof is omitted.

The second photocatalyst layer 26 may have a co-catalyst supported on its surface. In a case where the co-catalyst is supported, the water splitting efficiency becomes more satisfactory. Specific examples of the co-catalyst are as described above.

A method for supporting a co-catalyst in the second photocatalyst layer 26 is the same as the method for supporting a co-catalyst in the first photocatalyst layer 16, and thus the description thereof is omitted.

<Diaphragm>

The diaphragm 30 is disposed between the anode electrode 10 and the cathode electrode 20 so that ions included in the electrolytic solution S can freely enter and exit the anode electrode chamber 42 and the cathode electrode chamber 44, but the gas generated at the anode electrode 10 and the gas generated at the cathode electrode 20 do not mix.

A material constituting the diaphragm 30 is not particularly limited and includes a known ion-exchange membrane.

In FIG. 1, an example in which the diaphragm 30 is provided. However, the present invention is not limited thereto, and the diaphragm 30 may not be provided.

<Other Configurations>

The gas generated at the anode electrode 10 can be collected from a pipe (not shown in Figures) connected to the anode electrode chamber 42. The gas generated at the cathode electrode 20 can be collected from a pipe (not shown in Figures) connected to the cathode electrode chamber 44.

Although not shown in Figure, a supply pipe, a pump, and the like for supplying the electrolytic solution S may be connected to the bath 40.

FIG. 1 shows an example in which the inside of the bath 40 is filled with the electrolytic solution S; however, the present invention is not limited to this, and the inside of the bath 40 may be filled with the electrolytic solution S at the time of driving the device 1.

FIG. 1 shows the case in which both the anode electrode 10 and the cathode electrode 20 are photocatalytic electrodes having a photocatalyst layer; however, the present invention is not limited to this, and only the anode electrode 10 or the cathode electrode 20 may be a photocatalytic electrode.

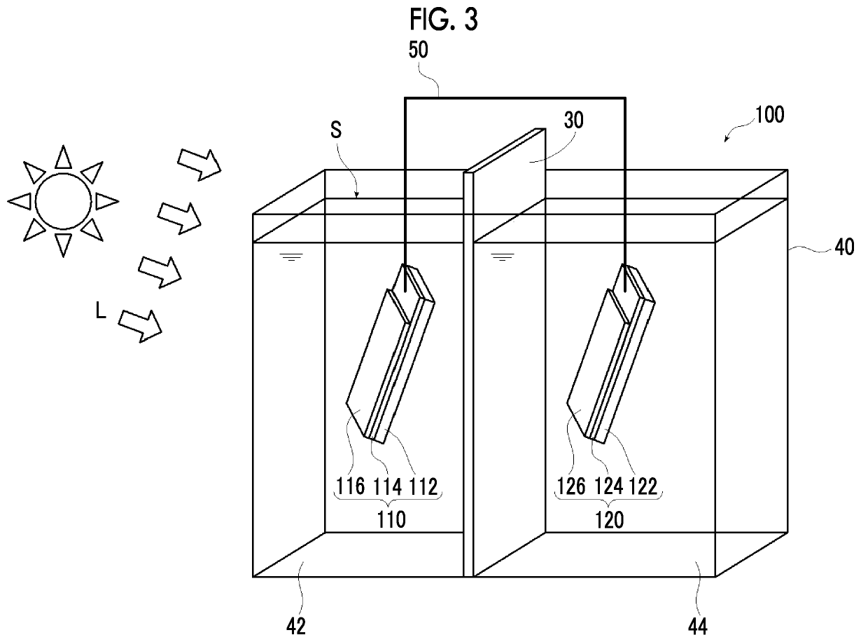

FIG. 1 shows an example in which the anode electrode 10, the diaphragm 30, and the cathode electrode 20 are arranged in this order along the direction intersecting the traveling direction of the light L. However, the present invention is not limited to this, and the water splitting device of the embodiment of the present invention may have the structure shown in FIG. 3.

FIG. 3 is a perspective view schematically illustrating a device 100 that is one embodiment of the water splitting device of the embodiment of the present invention. The device 100 is a device that generates gases from an anode electrode 110 and a cathode electrode 120 by irradiation with the light L. Specifically, in a case in which an electrolytic solution S that will be described later contains water as the main component, water is split by the light L, oxygen is generated from the anode electrode 110, and hydrogen is generated from the cathode electrode 120.

As shown in FIG. 3, the device 100 includes: a bath 40 filled with an electrolytic solution S; the anode electrode 110 and the cathode electrode 120 each disposed inside the bath 40; and a diaphragm 30 disposed between the anode electrode 110 and the cathode electrode 120 and inside the bath 40. The anode electrode 110, the diaphragm 30, and the cathode electrode 120 are arranged in this order along the traveling direction of the light L. Since the device 100 is the same as the device 1 in FIG. 1, except that the disposition of the anode electrode 110, the disposition of the cathode electrode 120, and the direction of irradiation with the light L are different from the device 1 of FIG. 1, the different points will be mainly described.

The anode electrode 110 is disposed in the bath 40 so that the first photocatalyst layer 116, the first conductive layer 114, and the first substrate 112 are arranged in this order from the side irradiated with the light L.

The cathode electrode 120 is disposed in the bath 40 so that the second photocatalyst layer 126, the second conductive layer 124, and the second substrate 122 are arranged in this order from the side irradiated with the light L.

The anode electrode 110 and the cathode electrode 120 are disposed to be inclined so that the amount of incident light per unit area increases.

In the device 100, the first substrate 112 and the first conductive layer 114 are preferably transparent in order to make the light L incident on the cathode electrode 120. As a result, the light that can not be absorbed by the first conductive layer 114 can be used by the cathode electrode 120, and thus there is an advantage that the light use efficiency per unit area is improved.

The term “transparent” in the present invention means that the light transmittance in the wavelength range of 380 nm to 780 nm is 60% or higher. The light transmittance is measured using a spectrophotometer. As the spectrophotometer, for example, V-770 (product name) manufactured by JASCO Corporation, which is an ultraviolet-visible spectrophotometer, is used.

One of the preferred aspects of the water splitting device of the embodiment of the present invention is an aspect in which a potential at an upper end of a valence band in the cathode electrode is −4.8 eV or less, and the anode electrode includes Nd₂CuO4 in which a part of Nd's may be substituted with an element of Group II of the periodic table or an element of Group III of the periodic table, among the photocatalysts for water splitting. Hereinafter, this aspect is also referred to as a first preferred aspect.

According to the first preferred aspect, the amount of generated gas of the water splitting device is more excellent due to the fact that the absorption efficiency of light in the visible light range is good and that generated electrons and holes that do not contribute to water splitting can be quickly recombined.

As a preferred aspect of Nd₂CuO₄ in which a part of Nd's may be substituted with an element of Group II of the periodic table or an element of Group III of the periodic table, a compound represented by Formula (4) is mentioned.

In the first preferred aspect, the potential at the upper end of the valence band in the cathode electrode is −4.8 eV or less and preferably −5.0 eV or less.

In order to adjust the potential at the upper end of the valence band in the cathode electrode to be in the above range, for example, CIGS, ZnSe—CIGS, La₂CuO₄, or the like may be used as a material constituting the photocatalyst layer included in the cathode electrode.

In the present invention, the potential at the upper end of the valence band can be measured using a photoelectron spectrometer (atmospheric photoelectron spectrometer, product name “AC-3”, manufactured by Riken Keiki Co., Ltd.).

In addition, since the configurations of the above-described device 1 can be applied to other configurations in the first preferred aspect, the description thereof is omitted.

One preferred aspect of the water splitting device according to the embodiment of the present invention is an aspect in which the cathode electrode includes, among the photocatalysts for water splitting described above, La₂CuO₄ in which a part of La's may be substituted with an element of Group II of the periodic table or an element of Group III of the periodic table except for a lanthanoid, and a potential at a lower end of a conduction band in the anode electrode is −5.2 eV or more. Hereinafter, this aspect is also referred to as a second preferred aspect.

According to the second preferred aspect, the amount of generated gas is more excellent in a case of applying to a water splitting device due to that fact that absorption efficiency of light in the visible light range is good and that generated electrons and holes that do not contribute to water splitting can be quickly recombined.

As a preferred aspect of La₂CuO₄ in which a part of La's may be substituted with an element of Group II of the periodic table or an element of Group III of the periodic table except for a lanthanoid, a compound represented by Formula (3) is mentioned.

In the second preferred aspect, the potential at the lower end of the conduction band in the anode electrode is −5.2 eV or more and preferably −5.0 eV or more.

In order to adjust the potential at the lower end of the conduction band in the anode electrode to be in the above range, for example, BiVO₄, BaTaO₂N, Nd₂CuO₄ or the like may be used as a material constituting the photocatalyst layer included in the anode electrode.

In the present invention, the potential at the lower end of the conduction band can be calculated by measuring the potential at the upper end of the valence band with the photoelectron spectrometer and adding this potential with the band gap obtained from the transmission spectrum.

In addition, since the configurations of the above-described device 1 can be applied to other configurations in the second preferred aspect, the description thereof is omitted.

As one of the preferred aspects of the water splitting device of the embodiment of the present invention, an aspect in which an electrode having a photocatalyst layer A formed using the above-described photocatalyst for water splitting and a photocatalyst layer B disposed on the photocatalyst layer A and formed using a photocatalyst different from the photocatalyst layer A is included and the conduction types of the photocatalyst layer A and the photocatalyst layer B are different from each other is mentioned. Hereinafter, this aspect is also referred to as a third preferred aspect.

Here, that the conduction types are different from each other means the case in which the photocatalyst layer B shows n-type in a case where the photocatalyst layer A shows p-type, and the photocatalyst layer B shows p-type in a case where the photocatalyst layer A shows n-type.

According to the third preferred aspect, quantum efficiency is improved since the excited carriers generated near the surface of the photocatalyst layer are subjected to charge separation by the depletion layer formed by the pn junction and thus recombination is reduced. Thereby, the amount of generated gas of the water splitting device is excellent.

The type of the photocatalyst contained in the photocatalyst layer B is not particularly limited as long as a photocatalyst layer of a conduction type different from that of the photocatalyst layer A can be formed.

In addition, since the configurations of the above-described device 1 can be applied to other configurations in the third preferred aspect, the description thereof is omitted.

As one of the preferred aspects of the water splitting device of the embodiment of the present invention, an aspect in which an electrode having a substrate and a photocatalyst layer disposed on the substrate and formed using the above-described photocatalyst for water splitting is included and the diffraction peak intensity of the (001) plane is 0% to 50% in a case where the sum of the diffraction peak intensities of the low index planes of the photocatalyst layer, which are measured by the X-ray diffraction method, is set to 1, is mentioned. Hereinafter, this aspect is also referred to as a fourth preferred aspect.

Here, the low index planes mean planes represented by (abc) (where a to c are all 0 or 1, and a+b+c≥1).

According to the fourth preferred aspect, since the carrier conduction of Ln₂CuO₄ is in a direction parallel to the (001) plane, the amount of generated gas of the water splitting device is more excellent in a case where the alignment is along the (010) or (100) orientation due to the fact that the carrier conduction in the surface direction of the photocatalyst layer is excellent.

As a material constituting the substrate, SrTiO₃, glass, or alumina is preferable.

The crystal plane orientation of the substrate is preferably (100) or (010) from the viewpoint that the crystal growth of the photocatalyst for water splitting constituting the photocatalyst layer is good.

In addition, since the configurations of the above-described device 1 can be applied to other configurations in the fourth preferred aspect, the description thereof is omitted.

### EXAMPLES

Hereinafter, the present invention will be described in more detail with reference to Examples. Materials, used amounts, ratios, treatments, treatment procedures, and the like described in Examples can be appropriately changed without departing from the spirit of the present invention. Therefore, the scope of the present invention should not be restrictively interpreted by the following Examples.

### Examples 1-1 to 1-5

Nd₂O₃ (neodymium (III) oxide, manufactured by Japan Pure Chemical Co., Ltd., purity 99.9%), CuO (copper (II) oxide, manufactured by Japan Pure Chemical Co., Ltd., purity 99.9%) and, as necessary, CeO (cerium (IV) oxide, manufactured by Japan Pure Chemical Co., Ltd., purity of 99.99% or more) were used as raw materials, each component was weighed so as to have a composition ratio shown in the composition formula of the compound (photocatalyst) shown in Table 1, and the raw materials were pulverized and mixed for 24 hours by a wet-type method using a ball mill (alumina balls having a diameter of 5 mm, rotation speed of 100 rpm).

The pulverized raw materials were taken out and temporarily calcinated at 800° C. for 12 hours. After temporary calcining, the mixture was pulverized and mixed in a mortar, and calcinated again at 950° C. to produce a compound (photocatalyst) of the composition formula shown in Table 1.

### Examples 1-6 to 1-8

Compounds (photocatalysts) shown in Table 1 were produced in the same manner as in the producing method of the compounds in Examples 1-1 to 1-5, except that La₂O₃ (lanthanum (III) oxide, manufactured by Japan Pure Chemical Co., Ltd., purity 99.99%), CuO, and, as necessary, SrO (manufactured by Japan Pure Chemical Co., Ltd.) were used as raw materials.

### Comparative Example 1-1

As the raw material, a compound (photocatalyst) shown in Table 1 was produced in the same manner as in the producing method of the compounds in Examples 1-1 to 1-5, except that Bi₂O₃ (manufactured by Japan Pure Chemical Co., Ltd.) and CuO were used, the temporary calcination temperature was changed to 600° C., and the calcination temperature after the temporary calcination was changed to 700° C.

### Comparative Example 1-2

A compound (photocatalyst) shown in Table 1 was produced in the same manner as in the producing method of the compounds in Examples 1-1 to 1-5, except that La₂O₃ and CuO were used as raw materials.

### Comparative Example 1-3

A compound (photocatalyst) shown in Table 1 was produced in the same manner as in the producing method of the compounds in Examples 1-1 to 1-5, except that CaO (manufactured by Japan Pure Chemical Co., Ltd.) and CuO were used as raw materials.

### Comparative Example 1-4

A compound (photocatalyst) shown in Table 1 was produced in the same manner as in the producing method of the compounds in Examples 1-1 to 1-5, except that NiO (manufactured by Japan Pure Chemical Co., Ltd.) and CuO were used as raw materials.

### Comparative Example 1-5

Niobium oxide (manufactured by Kojundo Chemical Lab. Co., Ltd.) and barium carbonate (manufactured by Kanto Kagaku) were mixed in an agate mortar to obtain a mixture. Each component was blended so that the atomic weight ratio was Nb/Ba=1/1.1. Next, the obtained mixture was placed in an electric furnace and calcinated at 1,000° C. for 10 hours to obtain an oxide precursor. This oxide precursor was placed in an electric tubular furnace and subjected to nitriding treatment at 900° C. for 10 hours under an ammonia gas flow to obtain BaNbO₂ N particles (photocatalyst).

### Comparative Example 1-6

Ta₂O₅ (manufactured by Japan Pure Chemical Co., Ltd.) was subjected to nitriding treatment at 850° C. for 15 hours in a vertical tube furnace under an ammonia gas flow to obtain Ta₃N₅ particles (photocatalyst).

<Identification of Photocatalyst>

The powdery compound (photocatalyst) produced as described above was subjected to structural analysis by an XRD (X-ray diffraction) method, and it was confirmed that the compound had a single phase. An X-ray diffractometer (product name “SmartLab”, manufactured by Rigaku Corporation) was used for the structural analysis by the XRD method.

(Measurement Conditions for Structural Analysis by XRD Method)

Light source: CuKα ray

2θ measurement range: 15 to 65 degrees

Scan speed: 1 degree/minute

Sampling interval: 0.02 degrees

<Evaluation of Responsiveness to Visible Light>

An electrode including a photocatalyst layer was prepared by a particle transfer method using the compound (photocatalyst) obtained as described above, and the responsiveness to visible light was evaluated.

(Production of Electrode Containing Photocatalyst)

Specifically, first, a suspension was prepared by suspending 50 mg of a powdery compound (photocatalyst) in 1 mL of 2-propanol by ultrasonic waves, this suspension was drop-cast on a glass substrate A (size: 10×30 mm) to volatilize 2-propanol in the suspension, and then a photocatalyst layer formed by depositing the powdery compound in a film form was formed on the glass substrate A.

Next, a Ti layer and a Sn layer serving as an electron collecting layer (lower electrode) were formed on the photocatalyst layer in this order. Specifically, the Ti layer (thickness: 0.6 μm) was formed on the photocatalyst layer by a vacuum vapor deposition method, and then the Sn layer (thickness: 4 μm) was formed on the Ti layer into a film, thereby producing a laminate A consisting of a Sn/Ti/photocatalyst/glass substrate A.

Next, a glass substrate B on which a carbon tape which is a substrate for transferring was adhered was prepared, the glass substrate B was adhered to the Sn layer of the laminate A, and then was peeled off at the interface between the glass substrate A and the photocatalyst layer to produce a laminate B in which the Sn layer, the Ti layer, and the photocatalyst layer were laminated in this order on the glass substrate B (photocatalyst/Ti/Sn/glass substrate B). Thereafter, a lead wire was connected to the Ti layer or the Sin layer of the laminate B so that the laminate B could be used as an electrode.

Next, Ir which is a co-catalyst was supported on the photocatalyst layer of the laminate B by a sputtering method to obtain a photocatalyst layer having a co-catalyst. The sputtering conditions were set so that the thickness of the layer constituted of the co-catalyst was 0.5 nm.

(Method for Evaluating Responsiveness to Visible Light)

Using the electrodes obtained as described above, evaluation of the responsiveness to visible light was performed.

Among the compounds (photocatalysts) shown in Table 1, the n-type compounds exhibit an anodic reaction, and thus, a compound having photocurrent that could be confirmed at 1 V (vs. RHE) was regarded as having the responsiveness to visible light. Since the p-type compounds show a cathodic reaction, a compound having photocurrent that could be confirmed at 0 V (vs. RHE) was regarded as having the responsiveness to visible light. Here, RHE is an abbreviation for reversible hydrogen electrode.

The photocurrent was confirmed by current-potential measurement in a three-electrode system using a potentiostat (manufactured by Hokuto Denko Corporation, product name “HSV-110”). As the light source, a solar simulator (manufactured by SAN-EI ELECTRIC CO., product name “XES-40S2-CE”, AM 1.5G) equipped with a filter L42 (Sharp cut filter manufactured by HOYA corporation) that cuts wavelengths below 420 nm was used. As the electrolytic solution, a H₃BO₃ electrolytic solution which had a pH adjusted to 9.5 with KOH was used.

<Evaluation of Amount of Generated Gas>

The amount of generated gas of the electrode (photocatalytic electrode) containing the produced photocatalyst was evaluated by a photoelectrochemical measurement in a three-electrode system using a potentiostat (product name “HZ-7000”, manufactured by Hokuto Denko Corporation).

Specifically, an electrochemical cell made of Pyrex (registered trade name) glass was used, each photocatalytic electrode of the above Examples and Comparative examples were used as a working electrode, an Ag/AgCl electrode was used as a reference electrode, and a Pt wire was used as a counter electrode. As the electrolytic solution, an H₃BO₃ electrolytic solution which had a pH adjusted to 9.5 with KOH was used.

The inside of the electrochemical cell was filled with argon, and dissolved oxygen and carbon dioxide were removed by performing sufficient bubbling before the measurement. As the light source, a xenon lamp (product name “LAMPHOUSER300-3J”, manufactured by Eagle Engineering Co., Ltd.) was used.

Water splitting was started at 1.3 V (vs. RHE) in a case where the photocatalytic electrode was n-type or at 0 V (vs. RHE) in a case where the photocatalytic electrode was p-type. Then, the amount of generated hydrogen (μmol/cm²) per 1 cm² of the photocatalytic electrode in a case where hydrogen was saved for 1 hour was measured by a micro gas chromatography (GC) analyzer. The larger the amount of generated hydrogen is, the better the amount of generated gas is.

<Measurement of Absorption Edge Wavelength>

The temporarily calcinated powdery compound obtained as described above was molded into a disk shape, and the resultant was fully calcinated at 950° C. (700° C. for a Bi-containing photocatalyst) to obtain a bulk sample for analysis. The absorption edge wavelength was determined by measuring the diffuse reflection spectrum of the produced disk-shaped sample using an ultraviolet-visible spectrophotometer (product name “V-770”, manufactured by JASCO Corporation) having an integrating sphere.

<Measurement of Conduction Type>

The conduction type (p-type or n-type) of the temporarily calcinated powdery compound (photocatalyst) was determined.

The conduction type was determined by a measuring device utilizing the Seebeck effect (product name “PN-12α”, manufactured by NAPSON Corporation).

<Evaluation of Durability>

The durability of the electrode (photocatalytic electrode) containing the produced photocatalyst evaluated by a photoelectrochemical measurement in a three-electrode system using a potentiostat (product name “HZ-7000”, manufactured by Hokuto Denko Corporation).

Specifically, an electrochemical cell made of Pyrex (registered trade name) glass was used, each photocatalytic electrode of the above Examples and Comparative examples were used as a working electrode, an Ag/AgCl electrode was used as a reference electrode, and a Pt wire was used as a counter electrode. As the electrolytic solution, an electrolytic solution in which a H₃BO₃ electrolytic solution was adjusted to pH 9.5 with KOH was used.

The inside of the electrochemical cell was filled with argon, and dissolved oxygen and carbon dioxide were removed by performing sufficient bubbling before the measurement. As a light source, a solar simulator (AM1.5G) (product name “XES-70S1” manufactured by SAN-EI ELECTRIC CO.) was used.

In a case where the photocatalytic electrode was for oxygen generation, 100 cycles of sweeping were performed, where one cycle was set as 0.3 to 1.3 V (vs. RHE) at 50 mv/s, and in a case where the photocatalytic electrode was for hydrogen generation, 100 cycles of sweeping were performed, where one cycle was set as 0 to 0.8 V (vs. RHE) at 50 mv/s. During sweeping, pseudo-sunlight was intermittently applied with a solar simulator (AM1.5G) at intervals of irradiation for 1 second and suspension for 1 second.

The durability was evaluated by the ratio of the photocurrent density at the 100th cycle to the photocurrent density at the first cycle [100×(photocurrent density at the 100th cycle)/(photocurrent density at the first cycle)].

The photocurrent density of 1.3 V (vs. RHE) was determined for the photocatalytic electrode for oxygen generation, and the photocurrent density of 0 V (vs. RHE) was determined for the photocatalytic electrode for hydrogen generation. The evaluation criteria are as follows.

A: The ratio of the photocurrent density at the 100th cycle to the photocurrent density of the first cycle is more than 75% and 100% or less.

B: The ratio of the photocurrent density at the 100th cycle to the photocurrent density of the first cycle is more than 50% and 75% or less.

C: The ratio of the photocurrent density at the 100th cycle to the photocurrent density of the first cycle is more than 25% and 50% or less.

D: The ratio of the photocurrent density at the 100th cycle to the photocurrent density of the first cycle is 25% or less.

<Evaluation Results>

Table 1 shows the results of evaluation tests of Examples 1-1 to 1-8 and Comparative examples 1-1 to 1-6.

TABLE 1

| | | Producing method of electrode | | | | | | | |
|---|---|---|---|---|---|---|---|---|---|
| | | including photocatalyst | | | | | | | |
| | | Producing | | | | Amount of | Absorption | | |
| | Composition | method of | Producing | Responsive- | | generated | edge | | |
| | formula of | photocatalyst | method of | ness to | Generated | hydrogen | wavelength | Conduc- | Dur- |
| | photocatalyst | layer | electrode | visible light | gas | (μmol/h) | (nm) | tion type | ability |
| Example 1-1 | Nd₂Cu0₄ | Solid phase | Particle transfer | Yes | Oxygen | 0.7 | 1,000 | n-type | A |
| | | method | method | | | | | | |
| Example 1-2 | Nd_{1.96}Ce_{0.04}CuO₄ | Solid phase | Particle transfer | Yes | Oxygen | 0.9 | 1,000 | n-type | A |
| | | method | method | | | | | | |
| Example 1-3 | Nd_{1.94}Ce_{0.06}CuO₄ | Solid phase | Particle transfer | Yes | Oxygen | 1 | 1,000 | n-type | A |
| | | method | method | | | | | | |
| Example 1-4 | Nd_{1.92}Ce_{0.08}CuO₄ | Solid phase | Particle transfer | Yes | Hydrogen | 0.6 | 1,000 | p-type | A |
| | | method | method | | | | | | |
| Example 1-5 | Nd_{1.90}Ce_{0.10}CuO₄ | Solid phase | Particle transfer | Yes | Hydrogen | 0.7 | 1,000 | p-type | A |
| | | method | method | | | | | | |
| Example 1-6 | La₂CuO₄ | Solid phase | Particle transfer | Yes | Hydrogen | 1 | 1,100 | p-type | A |
| | | method | method | | | | | | |
| Example 1-7 | La_{1.96}Sr_{0.04}CuO₄ | Solid phase | Particle transfer | Yes | Hydrogen | 1.2 | 1,100 | p-type | A |
| | | method | method | | | | | | |
| Example 1-8 | La_{1.90}Sr_{0.10}CuO₄ | Solid phase | Particle transfer | Yes | Hydrogen | 1.5 | 1,100 | p-type | A |
| | | method | method | | | | | | |
| Comparative | Bi₂CuO₄ | Solid phase | Particle transfer | Yes | Hydrogen | 0.2 | 650 | p-type | D |
| example 1-1 | | method | method | | | | | | |
| Comparative | CuLaO_{2.5} | Solid phase | Particle transfer | No | — | 0 | 500 | p-type | — |
| example 1-2 | | method | method | | | | | | |
| Comparative | CuCaO₂ | Solid phase | Particle transfer | No | — | 0 | 450 | p-type | — |
| example 1-3 | | method | method | | | | | | |
| Comparative | CuNiO₂ | Solid phase | Particle transfer | No | — | 0 | 450 | p-type | — |
| example 1-4 | | method | method | | | | | | |
| Comparative | BaNbO₂N | Solid phase | Particle transfer | Yes | Oxygen | 3.2 | 740 | n-type | C |
| example 1-5 | | method + | method | | | | | | |
| | | ammonia | | | | | | | |
| | | nitriding | | | | | | | |
| Comparative | Ta₃N₅ | Solid phase | Particle transfer | Yes | Oxygen | 1.6 | 600 | n-type | D |
| example 1-6 | | method + | method | | | | | | |
| | | ammonia | | | | | | | |
| | | nitriding | | | | | | | |

As shown in Table 1, it was shown that the photocatalyst containing the compound represented by Formula (1) is excellent in durability and responsiveness to visible light and can form a water splitting device excellent in the amount of generated gas (Example 1-1 to Example 1-8).

On the other hand, it was shown that in a case where a photocatalyst containing no compound represented by Formula (1) is used, at least one of durability, responsiveness to visible light, or the amount of generated gas in a case of being applied to a water splitting device is inferior (Comparative examples 1-1 to 1-6).

### Examples 2-1 and 2-2

A calcinated compound was obtained in the same manner as in Example 1-1 or 1-2.

### Examples 2-3 and 2-4

A calcinated compound was obtained in the same manner as in Example 1-6 or 1-8.

### Example 2-5

A calcinated compound was obtained in the same manner as in Example 1-6. In addition, powdery TiO₂ was prepared.

<Evaluation of Responsiveness to Visible Light>

An electrode including a photocatalyst layer was produced by a vapor phase growth method using the calcinated compound obtained as described above, and the responsiveness to visible light was evaluated.

(Production of Electrode Containing Photocatalyst)

First, a substrate was prepared in which SrRuO₃ was formed into a film having a thickness of 200 nm as a conductive layer on SrTiO₃. In addition, the temporarily calcinated compound (powdery shape) obtained as described above was molded into a disc shape and was fully calcinated at 950° C. to produce a target for film formation.

Next, a layer constituted of a thinned photocatalyst A was formed on the substrate of SrRuO₃ by the pulse laser deposition (PLD) method using the formed target for film formation (photocatalyst A/SrRuO₃/SrTiO₃). The film formation temperature was set to 650° C., and the thickness of the photocatalyst layer was adjusted to 100 to 300 nm in oxygen gas of 50 to 200 mTorr.

In Example 13, after forming a layer constituted of the photocatalyst A on SrRuO₃ of the substrate described above using a target for film formation of La₂CuO₄, a layer constituted of TiO₂ (photocatalyst B) having a thickness of 20 nm was formed into a film on the layer constituted of the photocatalyst A, using a TiO₂ target, under the same conditions as in the production of the layer constituted of the photocatalyst A (photocatalyst B/photocatalyst A/SrRuO₃/SrTiO₃).

Thereafter, a lead wire was connected to SrRuO₃ on the substrate in order to be used as an electrode.

(Method for Evaluating Responsiveness to Visible Light)

The responsiveness to visible light was evaluated in the same manner as the evaluation of the responsiveness to visible light of Example 1-1 described above, except that the electrode obtained as described above was used.

<Evaluation of Amount of Generated Gas>

The amount of generated gas was evaluated in the same manner as the evaluation of the amount of generated gas in Example 1-1 described above, except that the electrode obtained as described above was used.

<Measurement of Absorption Edge Wavelength>

A sample for measuring the absorption edge wavelength was prepared in the same manner as in the section of “Production of electrode containing photocatalyst” described above, except that SrTiO₃ was used as the substrate and the lead wire was not connected. The absorption edge wavelength was determined by measuring the transmission spectrum of the produced sample for measuring using an ultraviolet-visible spectrophotometer (product name “V-770”, manufactured by JASCO Corporation) having a measurement unit for a thin film.

<Measurement of Conduction Type and Carrier Density>

A sample for measuring the conduction type and the carrier density was produced in the same manner as in the section of “Production of electrode containing photocatalyst” described above, except that SrTiO₃ was used as the substrate and the lead wire was not connected.

Then, the conduction type (p-type or n-type) and the carrier density were determined by the Hall measurement using the sample for measuring thereof. The Hall measurement was performed using a Hall effect measurement device (Hall measurement system, manufactured by Toyo Corporation).

<Evaluation of Durability>

The durability was evaluated in the same manner as the evaluation of the durability of Example 1-1 described above, except that the electrode obtained as described above was used.

<Evaluation Results>

Table 2 shows the results of the evaluation tests of Examples 2-1 to 2-5.

TABLE 2

| | Composition | Composition | Producing | Responsive- | | Amount of | Absorption | | | |
|---|---|---|---|---|---|---|---|---|---|---|
| | formula of | formula of | method of | ness to | | generated | edge | | Carrier | |
| | photocatalyst | photocatalyst | photocatalyst | visible | Generated | hydrogen | wavelength | Conduc- | density | Dur- |
| | A | B | layer | light | gas | (μmol/h) | (nm) | tion type | (cm⁻³) | ability |
| Example 2-1 | Nd₂CuO₄ | — | Vapor phase | Yes | Oxygen | 1.1 | 1,000 | n-type | 5.0 × 10¹⁸ | A |
| | | | growth method | | | | | | | |
| Example 2-2 | Nd_{1.90}Ce_{0.10}Cu0₄ | — | Vapor phase | Yes | Hydrogen | 0.9 | 1,000 | p-type | 1.0 × 10¹⁸ | A |
| | | | growth method | | | | | | | |
| Example 2-3 | La₂CuO₄ | — | Vapor phase | Yes | Hydrogen | 1.7 | 1,100 | p-type | 3.0 × 10¹⁸ | A |
| | | | growth method | | | | | | | |
| Example 2-4 | La_{1.90}Sr_{0.10}CuO₄ | — | Vapor phase | Yes | Hydrogen | 1.9 | 1,100 | p-type | 6.0 × 10¹⁸ | A |
| | | | growth method | | | | | | | |
| Example 2-5 | La₂CuO₄ | TiO₂ | Vapor phase | Yes | Hydrogen | 2.2 | 1,100 | p-type | 1.2 × 10¹⁸ | A |
| | | | growth method | | | | | | | |

As shown in Table 2, it was shown that, even in a case where the photocatalyst is produced using a vapor phase growth method, a water splitting device which is excellent in durability and responsiveness to visible light and excellent in the amount of generated gas can be formed in a case where the photocatalyst containing the compound represented by Formula (1) is used (Example 2-1 to Example 2-5).

### EXPLANATION OF REFERENCES

1, 100: Device
10, 110: Anode electrode
12, 112: First substrate
14, 114: First conductive layer
16, 116: First photocatalyst layer
20, 120: Cathode electrode
22, 122: Second substrate
24, 124: Second conductive layer
26, 126: Second photocatalyst layer
30: Diaphragm
40: Bath
42: Anode electrode chamber
44: Cathode electrode chamber
50: Conducting wire
S: Electrolytic solution
L: light

What is claimed is:

1. A photocatalyst for water splitting, which is used for an electrode that generates gas by irradiation with light in a state of being immersed in water, the photocatalyst comprising:
a compound represented by Formula (1),
(Ln)₂CuO₄ Formula (1)
in Formula (1), Ln represents a lanthanoid, and a part of Ln's may be substituted with an element of Groups II to IV of the periodic table.

2. The photocatalyst for water splitting according to claim 1, further comprising:
a co-catalyst.

3. The photocatalyst for water splitting according to claim 1,
wherein the compound represented by Formula (1) is a compound represented by Formula (2),
(Ln)₂₋ₙAₙCuO₄ Formula (2)
in Formula (2), Ln represents a lanthanoid, A represents an element of Groups II to IV of the periodic table, and n represents a numerical value of 0 to 1.

4. The photocatalyst for water splitting according to claim 1, wherein in Formula (1), Ln is La or Nd.

5. The photocatalyst for water splitting according to claim 4, wherein in Formula (1), Ln represents La, and a part of La's may be substituted with an element of Group II of the periodic table or an element of Group III of the periodic table except for the lanthanoid.

6. The photocatalyst for water splitting according to claim 5, wherein a part of La's is substituted with Sr or Y.

7. The photocatalyst for water splitting according to claim 4, wherein in Formula (1), Ln represents Nd, and a part of Nd's may be substituted with an element of Group II of the periodic table or an element of Group III of the periodic table.

8. The photocatalyst for water splitting according to claim 7, wherein a part of Nd's are substituted with Ce or Y.

9. An electrode comprising:
the photocatalyst for water splitting according to claim 1.

10. A water splitting device for generating gases from a cathode electrode and an anode electrode by irradiating the cathode electrode and the anode electrode each disposed in a bath filled with water with light, wherein at least one of the cathode electrode or the anode electrode includes the photocatalyst for water splitting according to claim 1.

11. The water splitting device according to claim 10, wherein the cathode electrode includes La₂CuO₄ in which a part of La's may be substituted with an element of Group II of the periodic table or an element of Group III of the periodic table except for a lanthanoid, as the photocatalyst for water splitting, and a potential at a lower end of a conduction band in the anode electrode is −5.2 eV or more.

12. The water splitting device according to claim 10, wherein a potential at an upper end of a valence band in the cathode electrode is −4.8 eV or less, and the anode electrode includes Nd₂CuO₄ in which a part of Nd's may be substituted with an element of Group II of the periodic table or an element of Group III of the periodic table as the photocatalyst for water splitting.

13. The photocatalyst for water splitting according to claim 2,
wherein the compound represented by Formula (1) is a compound represented by Formula (2),
(Ln)₂₋ₙAₙCuO₄ Formula (2)
in Formula (2), Ln represents a lanthanoid, A represents an element of Groups II to IV of the periodic table, and n represents a numerical value of 0 to 1.

14. The photocatalyst for water splitting according to claim 2, wherein in Formula (1), Ln is La or Nd.

15. The photocatalyst for water splitting according to claim 14, wherein in Formula (1), Ln represents La, and a part of La's may be substituted with an element of Group II of the periodic table or an element of Group III of the periodic table except for the lanthanoid.

16. The photocatalyst for water splitting according to claim 15, wherein a part of La's is substituted with Sr or Y.

17. The photocatalyst for water splitting according to claim 14, wherein in Formula (1), Ln represents Nd, and a part of Nd's may be substituted with an element of Group II of the periodic table or an element of Group III of the periodic table.

18. The photocatalyst for water splitting according to claim 17, wherein a part of Nd's are substituted with Ce or Y.

19. An electrode comprising:
the photocatalyst for water splitting according to claim 2.

20. A water splitting device for generating gases from a cathode electrode and an anode electrode by irradiating the cathode electrode and the anode electrode each disposed in a bath filled with water with light, wherein at least one of the cathode electrode or the anode electrode includes the photocatalyst for water splitting according to claim 2.
